(19) United States
(12) Patent Application Publication
(10) Pub. No.: US 2017/0088265 A1
(43) Pub. Date: Mar. 30, 2017

(54) SEATBACK HOLDER FOR CELLULAR PHONES AND IPADS

(71) Applicant: David Douglas Brick, North Vancouver (CA)

(72) Inventor: David Douglas Brick, North Vancouver (CA)

(21) Appl. No.: 15/041,459

(22) Filed: Feb. 11, 2016

(30) Foreign Application Priority Data
Sep. 30, 2015 (CA) 2906681

(51) Int. Cl. B64D 11/00; B64D 11/06

(52) U.S. Cl. CPC B64D 11/00152; B64D 11/0638

(57) ABSTRACT

A seatback holder for cellular phones or iPads® configured to mount to the top ledge of a seat pocket or the top ledge of a tray tabletop on an aircraft seatback to hold a cellular phone or an iPad® at eye level while viewing video entertainment hands free.

The present invention relates generally to a holding apparatus for cellular phones and iPads®. More particularly the holding apparatus was designed to be used on commercial aircrafts to hold either a cellular phone or an iPad® at eye level on the back of an aircraft seatback while viewing inflight video entertainment hands free.

### BACKGROUND TO THE INVENTION

Technology and lifestyle has forced many North American commercial airlines to modernize their interior cabins by doing away with general television screens and individual seatback television screens in order to be WI-FI enabled. Once a plane reaches 10,000+ feet customers can stream live television, movies and video games on demand through personal media devices. Depending on the airline, this service can be free of charge providing the customer downloads the airlines app prior to take off or there may be a charge from a third party WI-FI provider. For customers that have not down loaded the airline's app prior to take off or for those customers that do not have a personal media device, most airlines will rent iPads® for a nominal charge so the customer can enjoy the same entertainment experience.

While using your own personal media device to view entertainment may seem convenient it can also present several problems. The airline industry is an extremely competitive industry and increasing the number of seats on a plane to maximize revenues is a number one priority. Now customers are faced with less space to stow and maneuver in their seat. So to enjoy a TV show or movie you now have to hold your media device in your hand which could become uncomfortable. Lowing the tray table to support your hand might help or perhaps you could prop up the media device with a magazine cover or a stand providing you had one with you. What happens when they serve a food tray or you want to multi task and do some computer work while listening or watching a video in the background? There is just no room to accommodate both, especially when your neighbor to your left and right are trying to do the exact same thing.

Another problem is when the seat in front of you is in a reclined position which further restricts the space around you making it even more awkward to view a hand held device.

The biggest problem of having to hold a media device to view entertainment would be during long haul flights. Tilting your head downward in an awkward position to view a media device held in your hand for sustained periods of time can cause repetitive strain injury (RSI) which is an injury to the musculoskeletal and nervous system caused by repetitive tasks or sustained awkward positions.

It is believed that there is a need in the art for a holder apparatus that will hold a cellular phone or iPad® at eye level on commercial aircraft seatbacks with the seat in either an upright or reclined position enabling customers to view inflight entertainment hands free and make their flight more comfortable. It is important that the holder apparatus be universal in design to accommodate different types of commercial aircraft seatbacks as well as a variety of ancillary cellular cases and iPad® covers.

Although the foregoing and the following description refers primarily to holder apparatus for cellular phones and iPads®, the present invention is not necessarily limited thereto. The present invention extends to other holding apparatus and equipment and the like which allows compatibility to hold a variety of hand held computer tablets, hand held readers and other portable electronic devices.

### SUMMARY OF THE INVENTION

Therefore it is the object of the invention to provide a cellular phone and iPad® holder which ameliorates the above mentioned problems. At the very least the object of the present invention is to provide an ergonomic alternative solution to the unprecedented situation and travelers comfort.

### Discussion of Preliminary Search Results

A preliminary search of patents related to cellular phone and iPad® holders for seatbacks in the Canadian Intellectual Property Office database and the United States Patent Office database found none that addressed the concept of holding a cellular phone or iPad® on the seatback of a commercial aircraft. The review did find the following seatback holder for tablet computers but it does not address cellular phones or iPads®;
CA 2849581 SEATBACK HOLDER FOR TABLET COMPUTERS
Hontz, Pozzi, Johnson 2015 Aug. 11
   four that relate to holding a cellular phone;
U.S. Pat. No. D685,366 S MEDIA HOLDER
Ding Jul. 2, 2013
U.S. Pat. No. D701,857 S MEDIA HOLDER
Ding Apr. 1, 2014
U.S. Pat. No. D705,211 S HANDSET CRADLE
Huang May 20, 2014
U.S. Pat. No. D684,963 S CELLULAR PHONE HOLDER
Goodrich Jun. 25, 2013
   two that relate to holding a cell phone with retention;
CA 2295217 CELLULAR PHONE HOLDER
Checklin
U.S. Pat. No. D713,398 S CELL PHONE HOLDER
Alesi et al. Sep. 16, 2014

### BRIEF SUMMARY OF THE INVENTION

According to one aspect of a holder apparatus for cellular phones and iPads® is provided herein configured for holding a cellular phone or iPad® for hands free viewing of entertainment.

In another aspect the holder apparatus is configured to hold and support a cellular phone or iPad® on the ledge of the cavity pocket on the supporting side of an aircraft seatback.

In yet another aspect the holder apparatus is configured to reasonably hold and support a cellular phone or iPad® on the top ledge portion of a tray tabletop seatback in an upright and locked position.

In yet another aspect the holder apparatus enables the angle of the cellular phone or iPad® to be adjusted relative to the size of the cellular phone or iPad®.

In yet another aspect the holder apparatus enables the angle of the cellular phone or iPad® to be adjusted relative to the position of a reclining seatback.

To achieve the foregoing and other aspects and advantages, in a first embodiment a holder apparatus for a cellular phone or iPad® is provided herein comprised of a one piece body consisting of a back, top, front and bottom base portion, the top portion has a center cut out and is configured to straddle the ledge of a seatback's cavity pocket or a tray tabletop when in an upright position enabling the tray tabletop latch to deploy and lock, a front portion is configured with a small hole cut out on the left and right side both to accommodate elastic bands to secure a cellular phone or iPad® to the holder apparatus when the seatback is in a reclined position or in the event of turbulence, the lower front portion has an angled bottom base configured to hold and support a cellular phone or iPad® for viewing of entertainment, the bottom base is configured to compensate for angle adjustment of the cell phone or iPad® relative to size and configuration of the cellular phone or iPad® and the position of the reclining seatback.

Additional features, aspects and advantages of the invention will be set forth in the detailed description which follows, and in part will be readily apparent to those skilled in the art form that description or recognized by practising the invention as described herein. It is to be understood that both the foregoing general description and the following detailed description present various embodiments of the invention, and are intended to provide an overview of framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

Embodiments of the invention are described below in detail, by way of example only, with references to the accompanying drawing and photos in which:

FIG. 1 is a schematic diagram of the cellular phone or iPad® holder in accordance with a first embodiment of the invention;

FIG. 2 is a photo of the holder of FIG. 1

FIG. 3 is a photo of the holder of FIG. 1 installed on the ledge of an aircraft's seatback cavity pocket;

FIG. 4 is a photo of the holder of FIG. 1 installed on the ledge of an aircraft's seatback cavity pocket with a cellular phone;

FIG. 5 is a photo of the holder of FIG. 1 installed on the ledge of an aircraft's seatback cavity pocket in the upright position with an iPad®;

FIG. 6 is a side view photo of the holder of FIG. 1 installed on the ledge of an aircraft's seatback cavity pocket in the upright position with an iPad®;

FIG. 7 is a photo of the holder of FIG. 1 installed on the ledge of an aircraft's seatback cavity pocket in the reclined position with an iPad®;

FIG. 8 is a photo of the holder of FIG. 1 installed on the top ledge of a tray tabletop in an upright and locked position;

FIG. 9 is a photo of the holder of FIG. 1 installed on the top ledge of a tray tabletop in an upright and locked position with a computer tablet;

FIG. 10 is a photo of the holder of FIG. 1 installed on the top ledge of a tray tabletop in an upright and locked position with an iPad® secured by the left and right elastic bands;

FIG. 11 is a rear view photo of the holder of FIG. 1 with an iPad® secured by the left and right elastic bands;

### DETAILED DESCRIPTION OF THE INVENTION

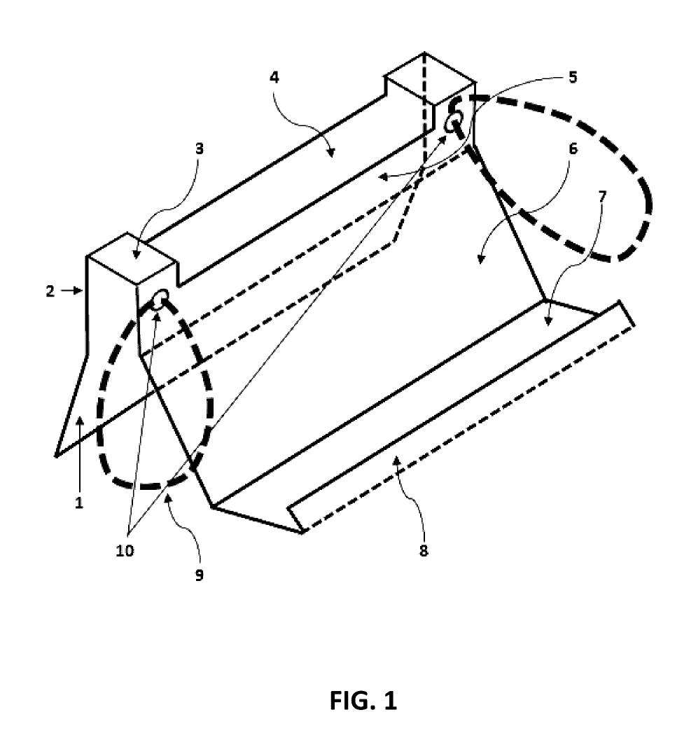

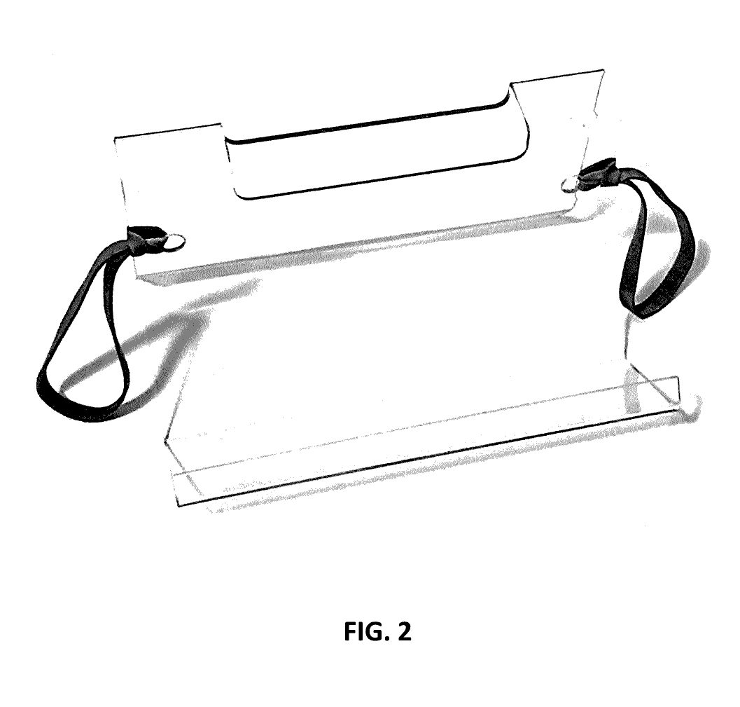

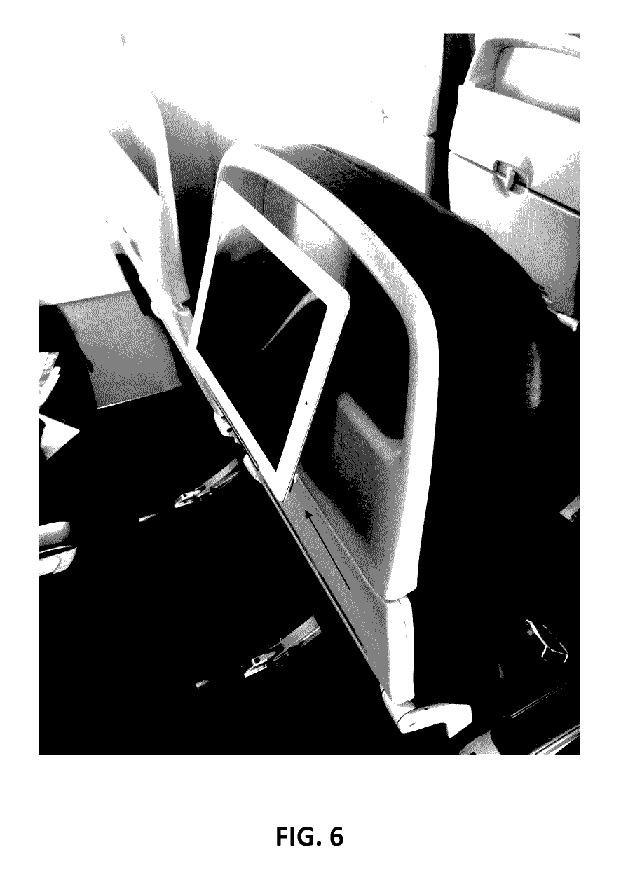

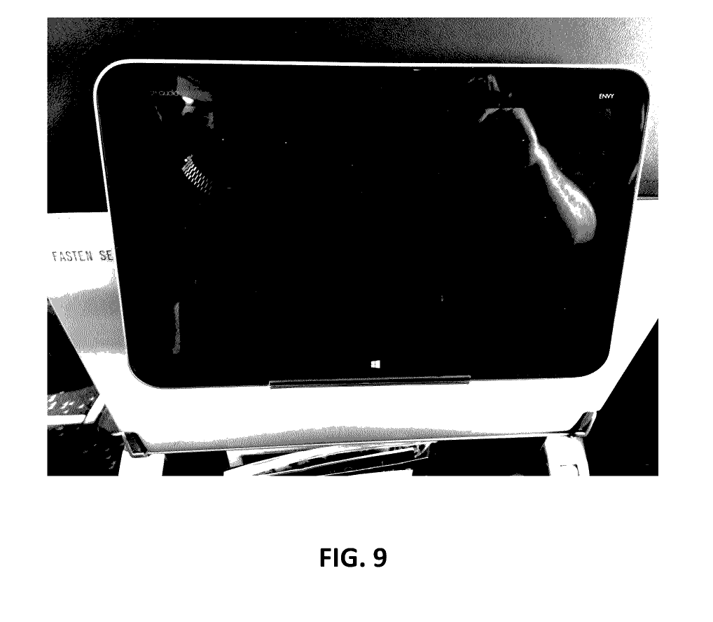

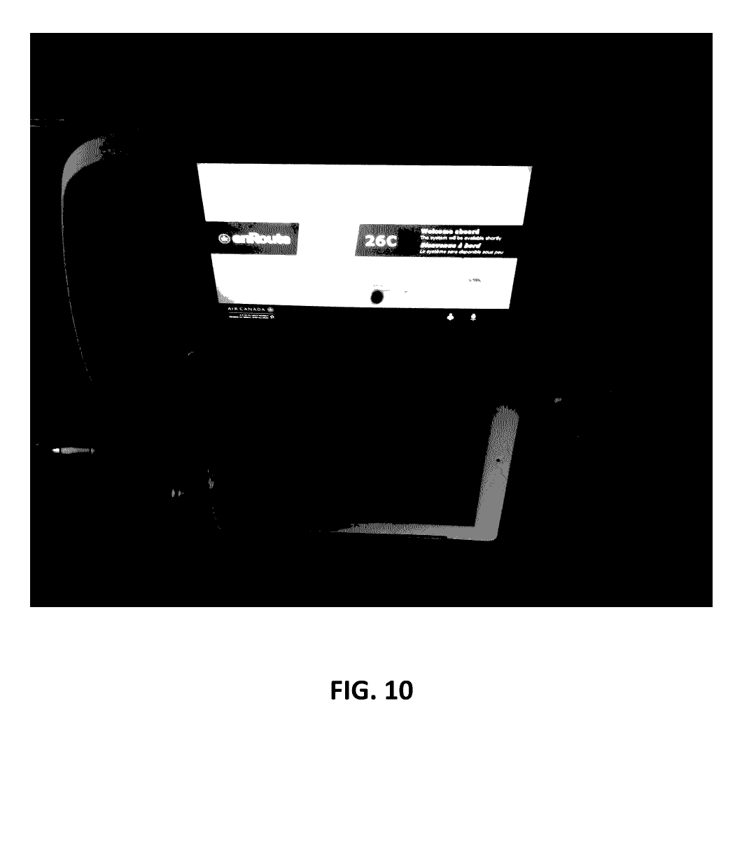

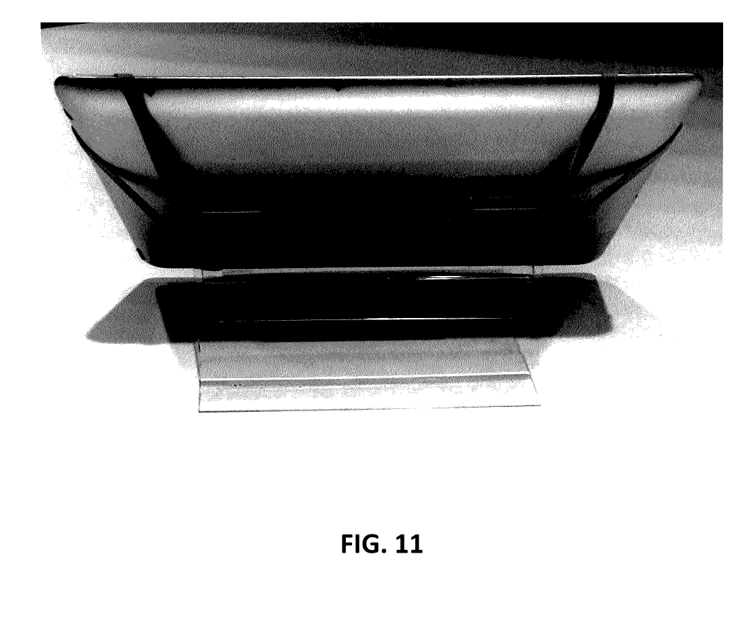

In describing the preferred embodiment of the present invention, reference will be made herein to FIGS. 1-11 of the drawings and photos in which like numerals refer to features of the invention.

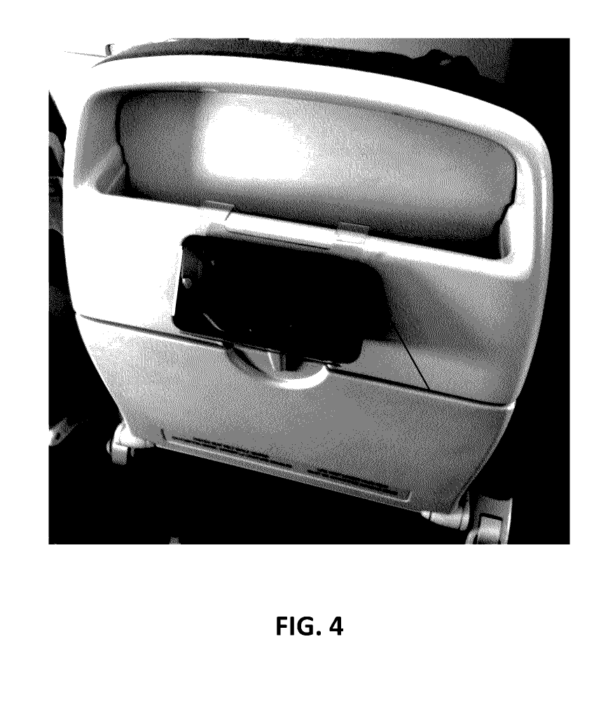

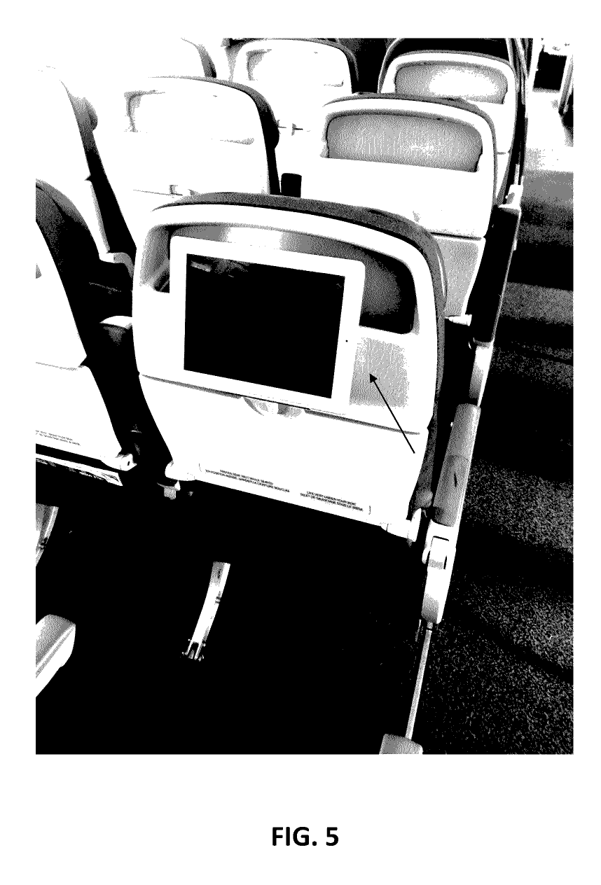

Referring to FIG. 1, a cellular phone and iPad® holder of the preferred embodiment of the present invention is to hold a cellular phone FIG. 4 or iPad® FIG. 5 at eye level on the back of an aircraft seatback while viewing inflight video entertainment hands free.

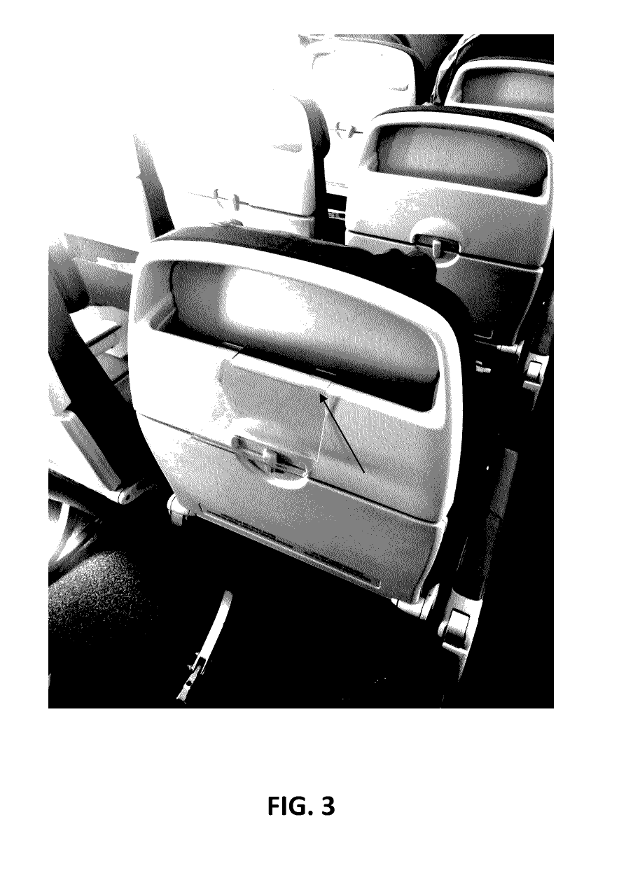

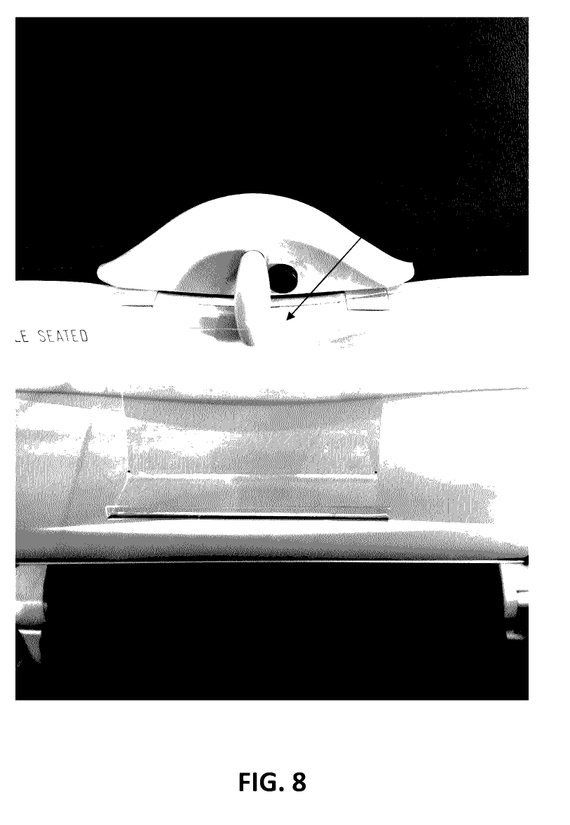

The holder FIG. 1 comprised of a one piece body configured to hold and support a cellular phone or iPad® on the top ledge of a cavity pocket on the supporting side of an aircraft seatback FIG. 3. On the top ledge of a tray tabletop of an aircraft seatback when in an upright and locked position FIG. 8.

The holder FIG. 1 is configured to easily be inserted or extracted without the use of any tools or devices and can hold a cellular phone or iPad® such that the cellular phone or iPad® can easily be inserted or extracted without the use of any tools or devices.

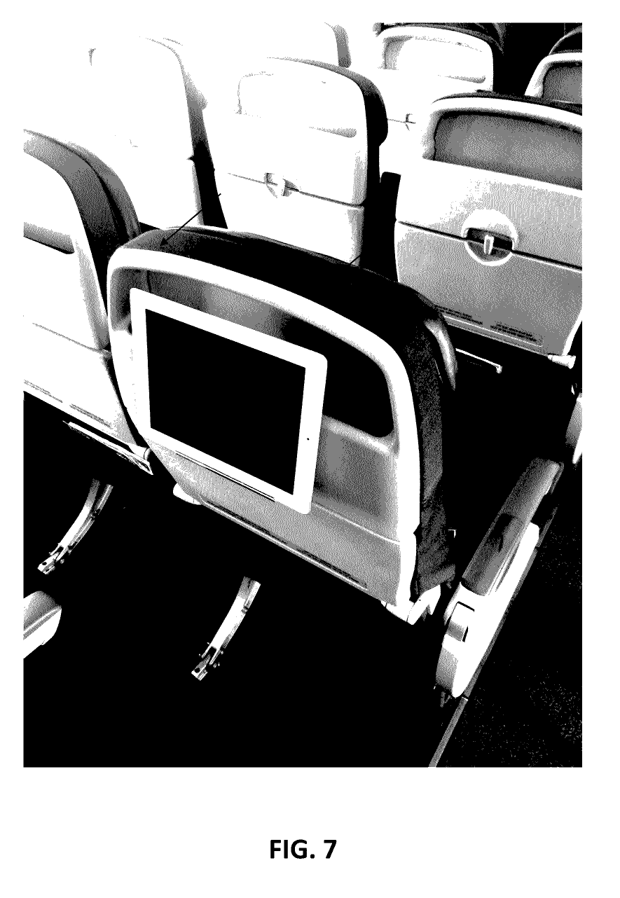

The holder FIG. 1 is a body consisting of several formed sides with a back portion FIG. 1 (1,2) designed for insertion into the cavity pocket of an aircraft seatback FIG. 3 and a lower tray tabletop portion of the seatback FIG. 8 when in an upright and locked position, a top portion FIG. 1 (3) is configured to straddle both the top ledge of the cavity pocket of the seatback and the top ledge of the tray tabletop portion of the seatback when in an upright and locked position, a centered cut out on the top portion FIG. 1 (4) to accommodate the latch deployment of the tray tabletop when in an upright locked position FIG. 8, an upper front portion FIG. 1 (5) is configured straight down to ensure a proper fit on the ledge of cavity pocket on the seatback and the ledge of the tray tabletop portion of the seatback when in an upright and locked position, the upper front portion FIG. 1 (5) is also configured with a left and right ¼″ diameter hole (10) to accommodate elastic bands (9), a lower front portion FIG. 1 (6) configured at 50 degrees away from the seatback to ensure the media device sits properly when the seat is in an upright FIG. 4, 5, 6 or reclined position FIG. 7, there is a lower front bottom base portion FIG. 1 (7) at a 75 degree angle away from the lower front portion FIG. 1 (6) is configured to accommodate various sizes of cellular phones and iPads® with various sizes of ancillary covers and to accommodate viewing angle of a cell phone or iPad® when the seatback is in an upright or reclined position, on the bottom base front portion FIG. 1 (7) there is a small lip return FIG. 1 (8) with a 90 degree angle facing upward to ensure the cellular phone or iPad® is secured properly therein when the seat is in an upright or reclined position.

The foregoing describes only one embodiment of the present invention, and modifications to those skilled in the art can be made thereto without departing from the scope of the present invention.

For example, the means of holding a cellular phone or iPad® in the apparatus is not limited to holding a cellular phone or iPad® described above but encompasses all forms of holding which could include fastening a cellular phone or iPad® to the apparatus with a strap or clip in the event of unforeseen air turbulence or an abrupt bump to the seatback which could cause the cellular phone or iPad® to fall from the holder. It is important to note that the holder requires the same amount of attention as a beverage or food item existing on a tray tabletop in the event of air turbulence or an abrupt hit to the seatback.

1. A seatback holder apparatus for a cellular phone or iPad®, said holder apparatus comprising a one piece body with two elastic bands, said body being defined by an upper and lower back side, a top side with a center cut out, an upper front side with a ¼″ diameter hole cut out on the left and right side to accommodate elastic bands and lower front side with a bottom base and a lip return, said upper back side, top side with a center cut out and upper front side are configured to straddle the ledge of an aircraft seatback cavity pocket and retain said holder on the ledge, said lower front body is angled at 50 degrees away from the seat back with said bottom base angled at 75 degrees away from said lower front side to hold and support a cellular phone or iPad® therein and allow for angle adjustability of the cellular phone or iPad® relative to the size of a cellular phone or iPad® and relative to the position of a reclining seatback, said front lip return on the bottom base is angled upwards at 90 degrees to hold and support a cellular phone or iPad® therein from slipping off the front of the holder.

2. The seatback holder apparatus recited in claim 1, wherein the upper backside, topside and upper front side portion together form a “U channel”.

3. The seatback holder apparatus recited in claim 2, wherein the “U channel” creates an interference fit with the ledge of the seatback.

4. The seatback holder apparatus recited in claim 1, wherein the lower front, bottom base and lip return together form an upward “U channel”.

5. The seatback holder apparatus recited in claim 4, wherein the upward “U channel” creates a platform to hold a cellular phone or iPad®.

6. The seatback holder apparatus recited in claim 4, wherein the bottom base is a minimum of 1¾ inches deep and 6 inches wide to compensate for angle adjustability.

7. The seatback holder apparatus recited in claim 5, wherein the platform is open faced enabling easy insertion and extraction of a cellular phone or iPad® from any direction above the holder.

8. The seatback holder apparatus recited in claim 5, wherein the downward pressure on the tray platform exerted from the weight of a cell phone or iPad® helps reinforce the interference fit of the holder on the seatback ledge recited in claim 3.

9. The seatback holder apparatus recited in claim 1, wherein the left and right ¼″ diameter holes accommodate the fastening of elastic bands to secure a cell phone or iPad® to the holder apparatus platform recited in claim 5.

10. A seatback holder apparatus for a cellular phone or iPad®, said holder apparatus comprising a one piece body with two elastic bands, said body being defined by an upper and lower back side, a top side with a center cut out, an upper front side with a ¼″ diameter hole cut out on the left and right side to accommodate elastic bands and lower front side with a bottom base and a lip return, said upper back side, top side and upper front side are configured to straddle the top ledge of a tray tabletop of an aircraft seatback when in an upright and locked position to retain said holder on the tray tabletop ledge, said lower front side is angled at 50 degrees away from the seat back with said bottom base angled at 75 degrees away from said lower front side to hold and support a cellular phone or iPad® therein and allow for angle adjustability of a cellular phone or iPad® relative to the size of the cellular phone or iPad® and relative to the position of a reclining seatback, said front lip return on said bottom base is angled upwards at 90 degrees to hold and support a cellular phone or iPad® therein from slipping off the front of the holder.

11. The seatback holder apparatus recited in claim 9, wherein the upper backside, topside and upper front side portion together form a “U Channel”.

12. The seatback holder apparatus recited in claim 10, wherein the “U Channel” creates an interference fit with the ledge of the tray table top.

13. The seatback holder apparatus recited in claim 9, wherein the top side center cut out is a minimum of 3½ inches long and centered on the top side.

14. The seatback holder apparatus recited in claim 12, wherein the top side center cut out is configured to accommodate the latch deployment of the tray tabletop.

15. The seatback holder apparatus recited in claim 13, wherein the latch deployment of the tray tabletop helps reinforce the interference fit of the holder on the tray tabletop ledge recited in claim 11.

16. The seatback holder apparatus recited in claim 9, wherein the lower front, bottom base and lip return together form an upward “U channel”.

17. The seatback holder apparatus recited in claim 15, wherein the upward “U channel” creates a platform to hold a cellular phone or iPad®.

18. The seatback holder apparatus recited in claim 15, wherein the bottom base is a minimum of 1¾ inches deep and 6 inches wide to compensate for angle adjustability.

19. The seatback holder apparatus recited in claim 16, wherein the platform is open faced enabling easy insertion and extraction of a cellular phone or iPad® from any direction above the holder.

20. The seatback holder apparatus recited in claim 10, wherein the left and right ¼″ diameter holes accommodate the fastening of elastic bands to secure a cell phone or iPad® to the holder apparatus platform recited in claim 17.
